(19) United States
(12) Patent Application Publication
(10) Pub. No.: US 2024/0423366 A1
(43) Pub. Date: Dec. 26, 2024

(54) SAFETY LATCH FOR A SLIDING DRAWER

(71) Applicant: Kindel Furniture Company, LLC, Grand Rapids, MI (US)

(72) Inventor: Anthony L. Klocko, Comstock Park, MI (US)

(21) Appl. No.: 18/745,934

(22) Filed: Jun. 17, 2024

Related U.S. Application Data
(60) Provisional application No. 63/509,451, filed on Jun. 21, 2023.

(51) Int. Cl. A47B 88/50; E05B 65/46

(52) U.S. Cl. CPC A47B 88/50; E05B 65/46

(57) ABSTRACT

A latch assembly includes a latch mounted to a drawer's side panel and a stopper mounted to a cabinet housing wall. The latch comprises a mounting structure, adapted to be mounted to the drawer's side panel, and a rod, designed to slide relative to the mounting structure. The rod includes a head structure, arranged inside the drawer's chamber, and a bolt structure, extending outwardly from the mounting structure. A biasing member surrounds the bolt structure, biasing it to an outward position. In this position, the bolt structure contacts the stopper, restricting the drawer's outward sliding relative to the cabinet housing. The latch assembly prevents unintentional drawer opening, enhancing safety in various applications, including industrial machinery, vehicle storage compartments, medical equipment, secure storage solutions, and aircraft overhead bins.

### CROSS REFERENCE TO RELATED APPLICATION

This application claims priority to U.S. Provisional Application No. 63/509,451, filed Jun. 21, 2023, which is hereby incorporated by reference in its entirety.

### BACKGROUND

### 1. Field of the Invention

The present disclosure relates to safety devices for furniture, and more particularly to a safety latch assembly designed to prevent unintentional opening or disengagement of sliding drawers.

### 2. Description of the Prior Art

During the year 2020 alone, furniture tip-over accidents caused injuries to people that resulted in about 18,000 emergency room visits in the U.S.A. And nearly half of those injuries were experienced by children. Furthermore, the Consumer Product Safety Commission also determined there were 581 deaths in the United States of America from 2000-2021, and about 80% of those killed were children. Although some of these injuries occurred from furniture that simply tipped over, one common cause of furniture tip-overs is due to extending one or more of the top drawers in a dresser or cabinet all the way out, thereby shifting the center of gravity forward and causing the entire article of furniture to fall onto the user. Children playing with dressers are particularly prone to injury because children might be more likely than an adult to pull out multiple drawers in a dresser, and children are smaller and weaker, and therefore more likely to be crushed, injured, and unable to free themselves.

Previous efforts have been made to reduce the number of injuries and deaths resulting from furniture tipping over onto people. One of those solutions was to secure the top of articles of furniture to the back wall using a bracket or strap. Although these solutions can be effective, they require the end user to physically secure the strap or bracket into the wall. This requires a certain level of expertise and tools, and it still might not be effective if the bracket or strap is secured only to drywall and not to any structural component like a wall stud. This also can be problematic for tenants who are not allowed to drill anything into the wall of their rental housing.

Therefore, previous efforts have been less effective than desired because those solutions required the end user to possess or access tools and related wall hardware, and also to possess the mechanical aptitude or ability to properly secure the bracket or strap to the wall. In short, these solutions required enough attention and expertise from the end user that they are often bypassed and not utilized. It also seems that there is a lack of safety education to encourage end users to safely secure furniture to the walls. Thus, there remains a need for an improved solution to keep articles of furniture from toppling over.

### SUMMARY

According to an aspect of the present disclosure, the latch assembly includes a latch mounted to a side panel of a drawer. The latch includes a mounting structure adapted to be mounted to the side panel of the drawer and defining an elongated channel. A rod extends through the elongated channel and is adapted to slide relative to the mounting structure. The rod includes a head structure adapted to be arranged inside a chamber of the drawer and a bolt structure coupled to the head structure and partially extending outwardly of the mounting structure. A biasing member is arranged surrounding the bolt structure and is configured to bias the bolt structure to an outward position. The latch assembly also includes a stopper mounted to a wall of a cabinet housing. In the outward position, the bolt structure is configured to contact the stopper coupled to the cabinet housing to restrict a sliding of the drawer relative to the cabinet housing in an outward direction.

According to other aspects of the present disclosure, the latch assembly may include one or more of the following features. The mounting structure may be adapted to be mounted to the side panel of the drawer and may define an elongated channel. The rod may extend through the elongated channel and may be adapted to slide relative to the mounting structure. The rod may include a head structure adapted to be arranged inside a chamber of the drawer and a bolt structure coupled to the head structure and partially extending outwardly of the mounting structure. The biasing member may be arranged surrounding the bolt structure and may be configured to bias the bolt structure to an outward position. The stopper may be mounted to a wall of a cabinet housing. In the outward position, the bolt structure may be configured to contact the stopper coupled to the cabinet housing to restrict a sliding of the drawer relative to the cabinet housing in an outward direction.

For a more complete understanding, reference is made to the following detailed description and accompanying drawings. In the drawings, like reference characters refer to like parts throughout the views in which:

### BRIEF DESCRIPTION OF THE DRAWINGS

FIG. 1 illustrates a top perspective view of a drawer assembly with a drawer in a partially open position, in accordance with an embodiment of the disclosure;

FIG. 2 depicts a top perspective view of the drawer assembly with the drawer partially extended from the cabinet housing, in accordance with an embodiment of the disclosure;

FIG. 3 presents a detailed front view of the latch assembly, in accordance with an embodiment of the disclosure;

FIG. 4 shows an exploded view of the latch assembly, highlighting the assembly and interaction of its components, in accordance with an embodiment of the disclosure; and

FIG. 5 provides another exploded view of the latch assembly, further detailing the assembly and interaction of its components, in accordance with an embodiment of the disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure provides a safety latch assembly 104 designed to prevent the unintentional opening or disengagement of sliding drawers. The safety latch assembly 104 may be particularly useful in various applications, including but not limited to, residential homes, industrial machinery, vehicle storage compartments, medical equipment, secure storage solutions, and aircraft overhead bins. The safety latch assembly 104 generally comprises a latch 120 mounted to a side panel of a drawer 102 and a stopper 122 mounted to a wall of a cabinet housing 200. The latch 120 may include a mounting structure 130 adapted to be mounted to the side panel of the drawer 102, defining an elongated channel 144, and a rod 132 extending through the elongated channel 144, adapted to slide relative to the mounting structure 130. The rod 132 may include a head structure 134 adapted to be arranged inside a chamber of the drawer 102, and a bolt structure 136 coupled to the head structure 134 and partially extending outwardly of the mounting structure 130. The latch 120 may further include a biasing member 138 arranged surrounding the bolt structure 136 and configured to bias the bolt structure 136 to an outward position. In the outward position, the bolt structure 136 may be configured to contact the stopper 122 coupled to the cabinet housing 200 to restrict a sliding of the drawer 102 relative to the cabinet housing 200 in an out ward direction. This configuration of the safety latch assembly 104 may enhance the safety of the drawer 102 by preventing it from unintentionally sliding open, thereby reducing the risk of accidents or injuries.

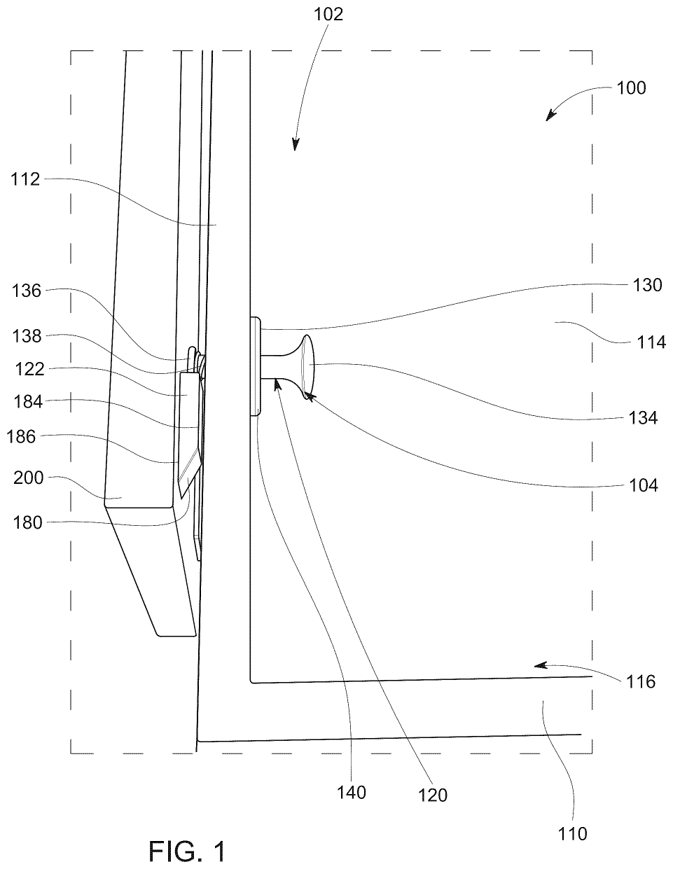

Referring to FIG. 1, the interaction between the latch assembly 104 and the stopper 122 in the partially open position of the drawer 102 is depicted. The latch assembly 104, mounted to the side panel 112 of the drawer 102, includes a latch 120 that interacts with the stopper 122, which is mounted to the cabinet housing 200. The latch 120 comprises a mounting structure 130, a rod 132, a head structure 134, a bolt structure 136, and a biasing member 138.

In some aspects, the bolt structure 136 of the latch 120 is shown in contact with the stopper 122. The stopper 122 functions to interact with the bolt structure 136 to control, or restrict, the movement of the drawer 102. It includes a ramp portion 180 that facilitates the movement of the rod 132 by providing a sloped surface that guides the bolt structure 136 as the drawer 102 is closed. The ramp portion 180 leads to a flat upper surface 184, which serves as a resting place for the bolt structure 136 when the drawer 102 is in a partially open position. The stopper 122 also features a butt end 182, which acts as a physical barrier to prevent further outward movement of the bolt structure 136, thereby restricting the drawer's movement. The stopper 122 is securely mounted to the cabinet housing 200 via a mounting surface 186, which may be affixed to the cabinet housing 200 using suitable fasteners or adhesives to ensure a stable and durable connection. The biasing member 138, which may be a spring 170, surrounds the bolt structure 136 and biases it to an outward position. This configuration prevents the drawer 102 from fully opening unless the latch 120 is intentionally disengaged by the user, thereby enhancing the safety and functionality of the drawer assembly 100.

In some cases, the bolt structure 136 is configured to contact the stopper 122 coupled to the cabinet housing 200 to restrict a sliding of the drawer 102 relative to the cabinet housing 200 in an outward direction. This interaction between the latch assembly 104 and the stopper 122 is particularly beneficial in preventing unintentional opening of the drawer 102, thereby enhancing the overall safety of the drawer assembly 100.

In other cases, the biasing member 138 may be configured to provide a different amount of biasing force. This variation in the biasing force can further enhance the safety of the drawer assembly 100 by adjusting the force that is applied to the bolt structure 136, thereby controlling the ease with which the drawer 102 can be opened.

In yet other aspects, the stopper 122 may be positioned at different locations along the cabinet housing 200 to accommodate different drawer 102 sizes or configurations. This flexibility in the positioning of the stopper 122 allows the latch assembly 104 to be used with a wide range of drawer 102 and cabinet designs, further enhancing its versatility and applicability.

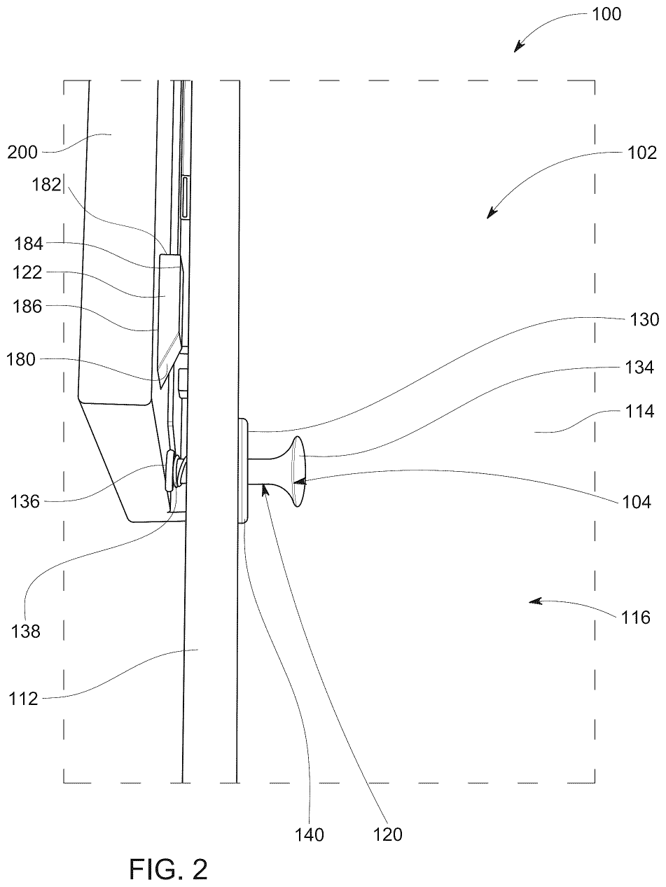

Referring to FIG. 2, the latch assembly 104 is depicted in an open position, with the drawer 102 partially extended from the cabinet housing 200. In this configuration, the bolt structure 136 of the latch 120 is shown in contact with the stopper 122. This interaction prevents the drawer 102 from being fully opened, enhancing the safety of the drawer assembly 100.

In some aspects, the bolt structure 136, extending outwardly from the mounting structure 130, is biased to an outward position by the biasing member 138. The biasing member 138, which may be a spring 170, surrounds the bolt structure 136 and applies a force that maintains the bolt structure 136 in an outward position. This configuration ensures that the bolt structure 136 remains in contact with the stopper 122, thereby preventing the drawer 102 from unintentionally sliding open.

Based upon the foregoing disclosure, it is seen that the present disclosure provides a safety latch assembly 104 that effectively prevents the unintentional opening of a drawer 102. The interaction between the bolt structure 136 and the stopper 122, along with the biasing force provided by the biasing member 138, ensures that the drawer 102 remains securely closed unless intentionally opened by a user. This enhances the overall safety of the drawer assembly 100, reducing the risk of accidents or injuries. Furthermore, the flexibility in the positioning of the stopper 122 and the adjustable biasing force provided by the biasing member 138 allows the latch assembly 104 to be used with a wide range of drawer and cabinet designs, enhancing its versatility and applicability.

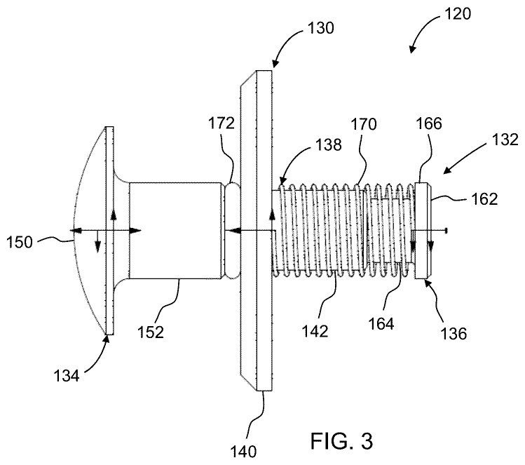

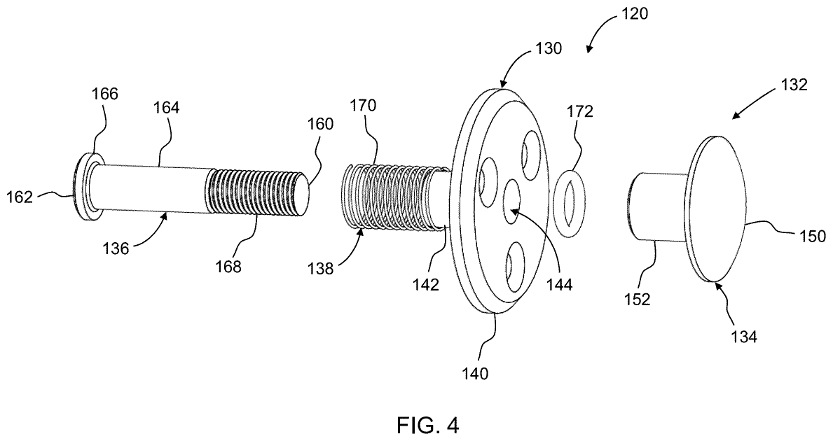

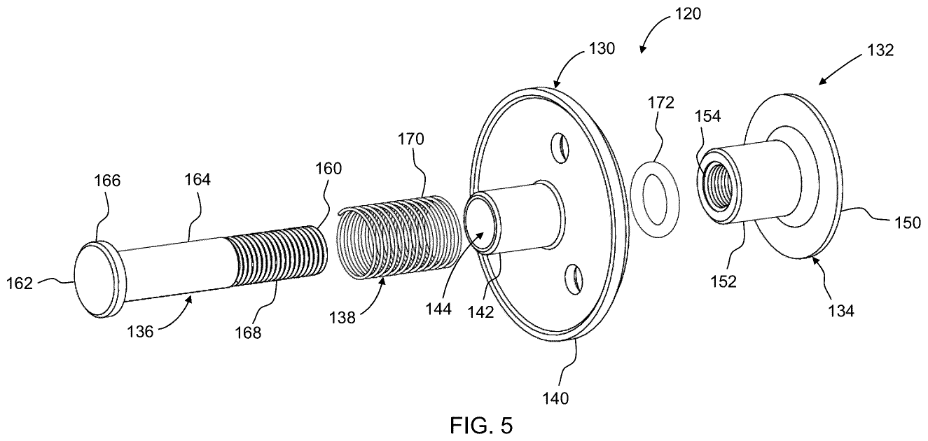

Referring to FIGS. 3, 4, and 5, the latch assembly 104 is depicted in a detailed front view and in various exploded views, showcasing its individual components and their arrangement. The latch assembly 104 includes a mounting structure 130, a rod 132, a head structure 134, a bolt structure 136, and a biasing member 138. The mounting structure 130, which may be made from different materials in various embodiments, includes a mounting plate 140 and a tube 142 extending longitudinally from the mounting plate 140. The mounting plate 140 defines an elongated channel 144 through which the rod 132 extends.

The mounting structure 130 is designed to be securely affixed to one of the side panels 112 of the drawer 102, ensuring that the latch assembly 104 remains stationary relative to the moving parts of the drawer 102. The mounting structure 130 is composed of two primary components: the mounting plate 140 and the tube 142. The mounting plate 140 offers a flat surface that interfaces with the drawer's side panel, and it can be attached using a variety of fasteners such as screws, bolts, or rivets, or by adhesive methods, depending on the drawer material and the desired strength of attachment. Extending from the mounting plate 140, the tube 142 provides a longitudinal pathway for the rod 132, guiding its movement and maintaining its alignment.

The mounting structure 130 is further characterized by an elongated channel 144 that runs through both the tube 142 and the mounting plate 140. The channel 144 allows the rod 132 to slide through the mounting structure 130. The dimensions and tolerances of the elongated channel 144 are such that they permit smooth movement of the rod 132 while preventing excessive play that could compromise the latch's effectiveness or durability.

Materials selected for the mounting structure 130 are chosen based on the requirements of strength, durability, and environmental resistance. Metals such as stainless steel or aluminum offer robustness and are often used for their resistance to corrosion and their ability to withstand substantial forces. These materials are particularly suitable for applications where the latch assembly 104 is subject to frequent use or is in an environment where moisture or chemicals are present. Non-corrosive metals such as brass or bronze may also be used, especially in applications where aesthetic considerations are paramount, as they provide a visually appealing finish that can complement the design of the furniture.

In applications where weight or cost is a concern, the mounting structure 130 may be constructed from high-strength plastics or composite materials. These materials can provide a balance between durability and weight, making them suitable for lighter-duty applications or for use in environments where metal corrosion could be an issue. Plastics and composites also offer the advantage of design flexibility, allowing for the creation of mounting structures with complex shapes or integrated features that might be more difficult or expensive to achieve with metal.

The rod 132 plays a pivotal role in the operation of the safety latch assembly 104, bridging the interaction between the user and the mechanical components that secure the drawer 102. Comprising a head structure 134 and a bolt structure 136, the rod 132 is engineered to withstand the forces exerted during the engagement and disengagement of the latch 120. The head structure 134, featuring a cap portion 150 and a tube portion 152, is the interface through which the user operates the latch 120. The cap portion 150 is ergonomically designed to facilitate easy gripping and manipulation, while the tube portion 152 serves as the structural body that houses the engaging threads and connects to the bolt structure 136. In some aspects, the head structure 134 may be fabricated from high-strength metal alloys, which provide the requisite durability and resistance to mechanical stress, ensuring the latch's longevity and reliability.

Alternatively, the head structure 134 may be constructed from durable plastics or advanced composite materials, which can offer benefits such as reduced weight and increased corrosion resistance. These materials can also allow for greater design versatility, enabling the creation of head structures with complex geometries or custom aesthetics that can seamlessly integrate with the design language of the furniture or equipment. The use of plastics and composites can further facilitate cost-effective manufacturing processes, such as injection molding, which can be advantageous for producing high volumes of components with consistent quality.

The bolt structure 136, which is integral to the rod 132, extends outwardly from the head structure 134 and is designed to interact with the stopper 122 to secure the drawer 102 in a closed or partially opened position. The bolt structure 136, which extends outwardly from the mounting structure 130, includes a first end 160, a second end 162 with a foot 166, and a shank 164 with external threads 168 that engage with the internal threads 154 of the head structure 134. The bolt structure 136 may be made from different materials in various embodiments. For instance, in some cases, the bolt structure 136 may be made from a high-strength metal alloy, while in other cases, it may be made from a durable plastic or composite material.

The biasing member 138, shown as a spring 170, surrounds the bolt structure 136 and is positioned between the mounting plate 140 and the foot 166 of the bolt structure 136. The biasing member 138 biases the bolt structure 136 to an outward position. In some aspects, the biasing member 138 may be made from different types of resilient materials or spring 170 materials, such as a torsion spring or a gas spring, depending on the specific requirements of the latch assembly 104.

Additionally, a bumper 172, depicted as a ring structure, is positioned between the tube portion 152 of the head structure 134 and the mounting plate 140 to dampen any impact from the head structure 134 hitting the mounting structure 130 when the latch 120 is released by a user. The bumper 172 may be made from different materials in various embodiments. For instance, in some cases, the bumper 172 may be made from rubber or an elastomeric material, while in other cases, it may be made from a different type of impact-absorbing material.

In some aspects, the dimensions and shape of the latch assembly 104 components could be varied. For instance, the mounting structure 130 could be made larger or smaller, or could be made in a different shape to fit different types of drawers. The rod 132 could be made longer or shorter, or could be made in a different shape to provide a different type of engagement with the stopper 122. The head structure 134 and bolt structure 136 could be configured to engage with the stopper 122 in a different manner. These variations in the dimensions and shape of the latch assembly 104 components allow for the latch assembly 104 to be used with a wide range of drawer 102 and cabinet designs, further enhancing its versatility and applicability.

In some aspects, the configuration of the latch assembly 104 components could be varied. For instance, the mounting structure 130 could be configured to be mounted to a different part of the drawer 102, such as the bottom or the back. The rod 132 could be configured to slide in a different direction relative to the mounting structure 130. The head structure 134 and bolt structure 136 could be configured to engage with the stopper 122 in a different manner. These variations in the configuration of the latch assembly 104 components allow for the latch assembly 104 to be used with a wide range of drawer and cabinet designs, further enhancing its versatility and applicability.

In operation, the user interacts with the latch assembly 104 to control the movement of the drawer 102. When the drawer 102 is in a partially open position, as shown in FIG. 1, the bolt structure 136 of the latch 120 is in contact with the stopper 122. This interaction prevents the drawer 102 from being fully opened unless the latch 120 is intentionally disengaged by the user.

To fully open the drawer 102, the user may hold the head structure 134 and pull it away from the mounting plate 140. This action compresses the biasing member 138, which may be a spring 170 in some aspects, causing the bolt structure 136 to slide inside the elongated channel 144. As a result, the foot 166 of the bolt structure 136 moves towards the side panel 112 of the drawer 102 and away from the butt end 182 of the stopper 122. This disengagement of the latch 120 allows the user to pull the drawer 102 outwardly from the cabinet housing 200.

Upon release of the head structure 134 by the user, the biasing member 138, or spring 170, expands and slides the bolt structure 136, and hence the rod 132, back to the outward position. This action ensures that the bolt structure 136 remains in contact with the stopper 122, thereby preventing the drawer 102 from unintentionally sliding open.

In some cases, the biasing member 138 may be configured to provide a different amount of biasing force. This variation in the biasing force can further enhance the safety of the drawer assembly 100 by adjusting the force that is applied to the bolt structure 136, thereby controlling the ease with which the drawer 102 can be opened.

In other aspects, the head structure 134 may be designed with different shapes or sizes to facilitate user interaction. For instance, the head structure 134 may be designed with a larger size or a specific shape to provide a better grip for the user. This can make it easier for the user to disengage the latch 120 when opening the drawer 102.

Based upon the foregoing disclosure, it is seen that the present disclosure provides a safety latch assembly 104 that effectively prevents the unintentional opening of a drawer 102. The interaction between the bolt structure 136 and the stopper 122, along with the biasing force provided by the biasing member 138, ensures that the drawer 102 remains securely closed unless intentionally opened by a user. This enhances the overall safety of the drawer assembly 100, reducing the risk of accidents or injuries. Furthermore, the flexibility in the positioning of the stopper 122 and the adjustable biasing force provided by the biasing member 138 allows the latch assembly 104 to be used with a wide range of drawer and cabinet designs, enhancing its versatility and applicability.

In some aspects, the operational parameters of the latch assembly 104 may be varied to suit different applications or requirements. For instance, the biasing member 138, which may be a spring 170 in some embodiments, could be configured to provide a specific amount of biasing force. This biasing force is applied to the bolt structure 136, biasing it to an outward position where it contacts the stopper 122. The specific amount of biasing force provided by the biasing member 138 may be adjusted based on the specific requirements of the drawer assembly 100. For example, a larger biasing force may be used for heavier drawers or drawers that are intended to hold heavier items, while a smaller biasing force may be used for lighter drawers or drawers that are intended to hold lighter items. This adjustable biasing force enhances the versatility of the latch assembly 104, allowing it to be used with a wide range of drawer and cabinet designs.

In other cases, the head structure 134 and the bolt structure 136 of the rod 132 may be configured to engage with the stopper 122 at a specific position. This engagement position may be adjusted based on the specific design of the drawer 102 and the cabinet housing 200. For instance, the engagement position may be adjusted to allow the drawer 102 to be opened to a specific extent before the bolt structure 136 contacts the stopper 122. This adjustable engagement position allows the user to control the extent to which the drawer 102 can be opened, enhancing the safety and usability of the drawer assembly 100.

In yet other aspects, the latch assembly 104 may be configured to provide a tactile or audible feedback to the user when the bolt structure 136 contacts the stopper 122. This feedback can alert the user that the drawer 102 has reached its maximum allowable opening extent, preventing unintentional overextension of the drawer 102. This feedback mechanism can further enhance the safety and usability of the drawer assembly 100.

Based upon the foregoing disclosure, it is seen that the present disclosure provides a safety latch assembly 104 that effectively prevents the unintentional opening of a drawer 102. The interaction between the bolt structure 136 and the stopper 122, along with the adjustable biasing force provided by the biasing member 138 and the adjustable engagement position of the head structure 134 and bolt structure 136 with the stopper 122, ensures that the drawer 102 remains securely closed unless intentionally opened by a user. This enhances the overall safety of the drawer assembly 100, reducing the risk of accidents or injuries. Furthermore, the flexibility in the positioning of the stopper 122 and the adjustable operational parameters of the latch assembly 104 allow the latch assembly 104 to be used with a wide range of drawer 102 and cabinet designs, enhancing its versatility and applicability.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. A safety latch assembly for a sliding drawer, comprising:
a latch configured to be mounted to a side panel of the drawer, the latch including a mounting structure defining an elongated channel, a rod extending through the elongated channel and adapted to slide relative to the mounting structure, the rod including a head structure arranged inside a chamber of the drawer and a bolt structure coupled to the head structure and partially extending outwardly of the mounting structure, and a biasing member arranged surrounding the bolt structure and configured to bias the bolt structure to an outward position; and
a stopper mounted to a wall of a cabinet housing, wherein in the outward position, the bolt structure is configured to contact the stopper to restrict a sliding of the drawer relative to the cabinet housing in an outward direction.

2. The safety latch assembly of claim 1, wherein the mounting structure is made from a non-corrosive metal selected from the group consisting of brass, bronze, stainless steel, and aluminum.

3. The safety latch assembly of claim 1, wherein the biasing member is a compression spring.

4. The safety latch assembly of claim 1, wherein the bolt structure is configured to contact the stopper coupled to the cabinet housing to restrict the drawer from sliding fully open relative to the housing unless the latch is intentionally disengaged at an elevated position by the user.

5. The safety latch assembly of claim 1, further comprising a bumper arranged between the head structure and the mounting structure to dampen any impact from the head structure hitting the mounting structure when the latch is released by a user.

6. The safety latch assembly of claim 3, wherein the compression spring is made from a material selected from the group consisting of steel, stainless steel, and a metal alloy.

7. The safety latch assembly of claim 1, wherein the head structure of the rod includes a cap portion and a tube portion, the tube portion having internal threads for engaging with external threads on the bolt structure.

8. The safety latch assembly of claim 7, wherein the cap portion of the head structure is configured to be gripped by a user to manually disengage the latch.

9. The safety latch assembly of claim 5, wherein the bumper is made from a material selected from the group consisting of rubber, silicone, and an elastomeric material.

10. The safety latch assembly of claim 1, wherein the stopper mounted to the wall of the cabinet housing includes a ramp portion and a butt end, the ramp portion facilitating the movement of the rod during the closing of the drawer.

11. The safety latch assembly of claim 1, wherein the latch is configured to be mounted to a side panel of the drawer using fasteners selected from the group consisting of screws, bolts, and rivets.

12. In combination, a latch and a stopper, the combination comprising:
a latch assembly including a mounting structure defining an elongated channel, a rod extending through the elongated channel and adapted to slide relative to the mounting structure, the rod including a head structure arranged inside a chamber of the drawer and a bolt structure coupled to the head structure and partially extending outwardly of the mounting structure, and a biasing member arranged surrounding the bolt structure and configured to bias the bolt structure to an outward position; and
a stopper having a ramp portion, a butt end, a flat upper surface, and a mounting surface, the ramp portion being angled at an incline from the mounting surface to the flat upper surface, and the butt end being positioned between the mounting surface and the flat upper surface at a location opposite of the ramp portion.

13. The combination of claim 12, wherein the mounting structure is made from a non-corrosive metal.

14. The combination of claim 12, wherein the biasing member is a compression spring.

15. The combination of claim 12, wherein the head structure of the rod includes a cap portion and a tube portion, the tube portion having internal threads for engaging with external threads on the bolt structure.

16. The combination of claim 12, further comprising a bumper arranged between the head structure and the mounting structure to dampen any impact from the head structure hitting the mounting structure when the latch is released by a user.

17. The combination of claim 12, wherein the latch assembly is configured to be mounted to a side panel of a drawer using fasteners.

18. The combination of claim 12, wherein the cap portion of the head structure is configured to be gripped by a user.

19. The combination of claim 14, wherein the compression spring is made from a resilient material.

20. The combination of claim 16, wherein the bumper is made from an impact-absorbing material.
